(19) United States
(12) Patent Application Publication
(10) Pub. No.: US 2022/0032893 A1
(43) Pub. Date: Feb. 3, 2022

(54) ELECTRICALLY-DRIVEN AXLE

(71) Applicants: ZF Friedrichshafen AG, Friedrichshafen (DE); ZF DRIVETECH (SUZHOU) CO. LTD., Suzhou/Jiang Su (CN)

(72) Inventors: Frank SEEMANN, Euerbach (DE); Paul LENZ, Waldkirchen (DE); Andreas GROSSL, Kopfing (AT); Werner HECHBERGER, Fuerstenzell (DE); Kai BORNTRAEGER, Langenargen (DE); Maik WOERL, Immenstaad (DE); Marco DI SARNO, Osnabrück (DE); Cong REN, Suzhou, Jiang Sui (CN)

(21) Appl. No.: 17/277,415

(22) PCT Filed: Sep. 13, 2019
(86) PCT No.: PCT/EP2019/074448

§ 371 Date: Mar. 18, 2021

(30) Foreign Application Priority Data
Sep. 19, 2018 (DE) 10 2018 215 935.1

(51) Int. Cl. B60T 17/08

(52) U.S. Cl. CPC B60T 17/086; B60T 17/088

(57) ABSTRACT

An electrically driven axle with electrical drive units (4) arranged symmetrically around the axle body (1). The drive units having an electric machine and a transmission, and at least one spring-loaded brake (3) as a parking brake. The spring-loaded brakes (3) are arranged radially, thus enabling the spring-loaded brake (3) to be released by removing a release spindle (7) from brake cylinders of the spring-loaded brakes (3).

This application is a National Stage completion of PCT/EP2019/074448 filed Sep. 13, 2019, which claims priority from German patent application serial no. 10 2018 215 935.1 filed Sep. 19, 2018.

### FIELD OF THE INVENTION

The invention relates to an electrically driven axle.

### BACKGROUND OF THE INVENTION

Driven axles in the sector of heavy vehicle categories (utility vehicles and buses) in most cases consist of a drive unit, a differential, the axle body, which is connected to the body of the vehicle by means of control arms, and the driveshafts. The drive unit can be in the form of a conventional drive unit, a hybrid drive or an electric drive.

For example, from DE 10 2012 204 717 A1 by the present applicant an electrically motorized drive mechanism is known, with which two drive units in the form of electric machines with a planetary gearset, a spur gear drive and a drive output are connected in order to drive a vehicle or a vehicle axle. The drive mechanisms can be fitted directly on the axle as an axle drive, or as described, as a near-axle drive. Axle drives entail the challenge of accommodating all the components in a predetermined structural fitting space.

Particularly in the case of portal axles for lowering the level of the vehicle floor, fitting space is a decisive factor. Relative to the drive wheels, the axle body must be positioned lower down and the axle drive is in addition arranged eccentrically in order to provide space in the middle of the axle for the vehicle floor. This can then fit into the completed vehicle almost unchanged.

From the document US 2005/0023053 A1 an axle arrangement is known, that also comprises two electric motors or drive units which, however, are arranged around the axle body. In that way there is just enough fitting space for further axle components. Particularly with the spring-loaded brakes used in utility vehicles, the result of this can be that in a defective vehicle these can no longer be released. However, when a vehicle has to be towed it must be possible to unlock the spring-loaded brake used as the parking brake. As a rule this is done by loosening a release spindle in the brake cylinder of the spring brake. However, since there is only just enough space between the brake cylinder and the drive unit or units or the transmission housing, the space available for loosening the release spindle is restricted. If the brake pads of the disk brakes are worn, the fitting space is reduced even more.

### SUMMARY OF THE INVENTION

The purpose of the present invention is to develop further an electrically driven axle with two drive units, in such manner that the parking brake can be released at any time.

The invention achieves this by using a spring-loaded brake in an electrically driven axle, in combination with an axle having two drive units which are arranged close to the axle and symmetrically around the axle body, and are connected to a transmission. Compared with axial spring-loaded brakes the brake cylinder is rotated through 90° and is thus at a right-angle to the axle, so that by virtue of the new position of the brake cylinder, the brakes can be released even if the brake pads are worn.

The drive units comprise a drive and a transmission, wherein the transmission can be of countershaft or of planetary design. They are arranged centrally in the middle of the axle between the drive wheels and have a housing. The spring-loaded brakes are provided between this housing of the drive units and the vehicle brakes, whereby they are arranged in the longitudinal direction (action direction) between the axle body of the axle and an air spring.

The axle is driven by two drive units, which are arranged at the middle of the axle. Preferably, the two drive units are arranged symmetrically around the axle in such manner that one drive unit is positioned in front of the axle in the direction of travel and one drive unit is arranged behind the axle in the direction of travel. The fitting space problem for loosening the release spindle of the parking brake occurs to the left and right on the axle, between the brake cylinders and the housing of a drive unit.

### BRIEF DESCRIPTION OF THE DRAWINGS

The invention will be explained in greater detail with reference to the following figures:

FIG. 1: Installation of an axial brake according to the prior art

FIG. 2: Installation of a radial brake according to the invention

### DETAILED DESCRIPTION OF THE PREFERRED EMBODIMENTS

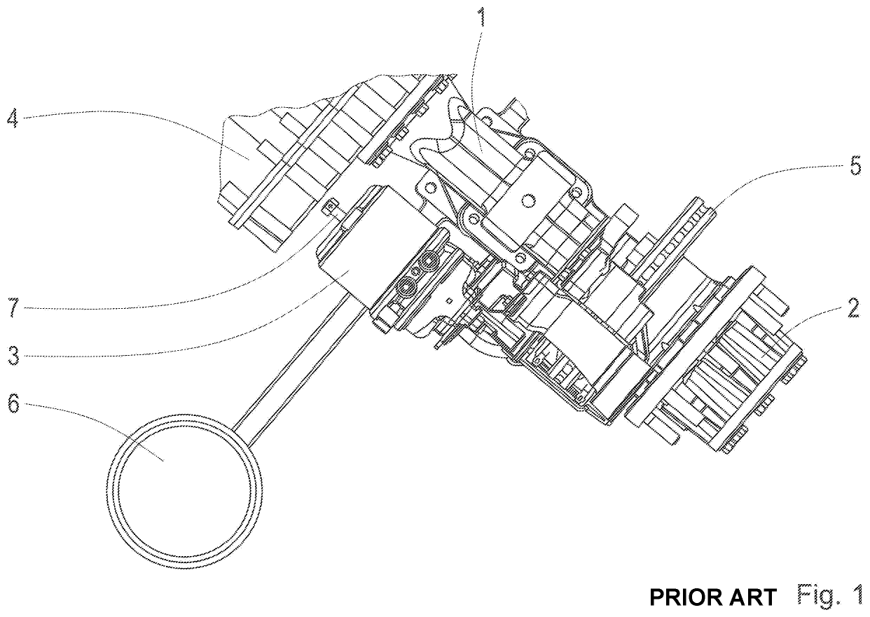

FIG. 1 shows the installation, known from the prior art, of spring-loaded brakes 3 which are orientated axially relative to the axle body or its axis. On the side of the spring-loaded brake 3 facing away from the drive wheel, which consists among other things of a brake cylinder and a spring, a release spindle 7 is fitted by means of which the brake can be unlocked, for example when the vehicle has to be towed. The release spindle 7 has to be unscrewed, but when the release spindle is unscrewed it moves in the direction of the drive unit 4. Since there is very little free space here, it is difficult to loosen the release spindle 7. Furthermore the free space situation can be made worse by worn brake pads, which press against the brake disks 5 of the vehicle's brakes, since because of that the spring-loaded brake is displaced farther in the direction of the drive unit 4.

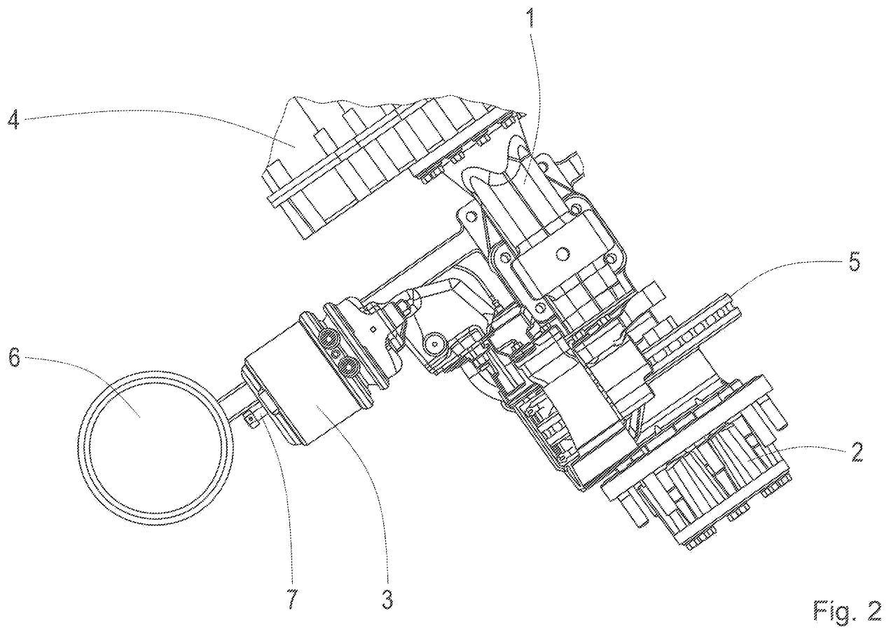

FIG. 2 shows a solution according to the invention. In this case the spring-loaded brake 3 is no longer installed axially relative to the axis of the axle body 1, but rather, rotated by 90° relative to the axis of the axle body 1, so that now, in its action direction, it is installed between the axle body 1 and the air spring 6. Thus, the release spindle 7 of the spring-loaded brake 3 is unscrewed in the direction of the air spring brake 6 or radially relative to the axis of the axle body 1 when the brake is to be unlocked manually. This is possible without any problems due to the larger installation space at this point. Furthermore, the release spindle 7 is in that way better accessible from the outside, from the side of the drive wheel fitted onto the hub 2, since the release spindle 7 is no longer arranged behind a component, namely the parking brake 3 itself. The release spindle 7 is therefore more easily accessible from the side of the drive wheel. Moreover, when it is unscrewed the release spindle 7 does not have to be opened or unscrewed from the side of the drive wheel out of the vehicle, but can be loosened radially relative to the vehicle's axle, which makes loosening it simpler.

### INDEXES

1 Axle body

2 Hub of the drive wheel

3 Spring-loaded brake

4 Drive unit

5 Brake disk

6 Air spring

7 Release spindle

1-6. (canceled)

7. An electrically driven axle comprising:
electrical drive units (4) being arranged symmetrically around an axle body (1),
the drive units having an electric machine and a transmission,
at least one spring-loaded brake (3) as a parking brake, and
the spring-loaded brakes (3) being arranged radially, thus enabling the spring-loaded brake (3) to be released from brake cylinders of the spring-loaded brakes (3) by virtue of a new position of a release spindle (7).

8. The electrically driven axle according to claim 7, wherein the brake cylinders of the spring-loaded brakes (3) are arranged rotated through 90°.

9. The electrically driven axle according to claim 7, wherein the drive units (4) comprise transmissions of a countershaft design.

10. The electrically driven axle according to claim 7, wherein the drive units (4) comprise transmissions of a planetary design.

11. The electrically driven axle according to claim 7, wherein the drive units are arranged at a middle of the axle.

12. The electrically driven axle according to claim 7, wherein the spring-loaded brakes (3) are arranged between vehicle brakes (5) and the drive units (4).

13. An electrically driven axle comprising:
an axle body (1) extending along a lateral axis;
electrical drive units (4) being arranged symmetrically around the axle body, and each of the drive units having an electric machine and a transmission;
at least one spring-loaded brake (3) as a parking brake, the spring-loaded brakes (3) being arranged perpendicularly relative to the lateral axis, and the spring-loaded brake (3) having a release spindle (7) which is movable perpendicularly relative to the lateral axis to release the spring-loaded brakes (3) from brake cylinders of the spring-loaded brakes (3).
